(19) United States
(12) Patent Application Publication
(10) Pub. No.: US 2022/0020980 A1
(43) Pub. Date: Jan. 20, 2022

(54) NEGATIVE ACTIVE MATERIAL FOR RECHARGEABLE LITHIUM BATTERY AND RECHARGEBALE LITHIUM BATTERY INCLUDING SAME

(71) Applicant: SAMSUNG SDI CO., LTD., Yongin-si (KR)

(72) Inventors: Changsu SHIN, Yongin-si (KR); Heeyoung CHU, Yongin-si (KR); Youngugk KIM, Yongin-si (KR); Jaemyung KIM, Yongin-si (KR); Chul YOUM, Yongin-si (KR); Jongmin WON, Yongin-si (KR); Dae-Hyeok LEE, Yongin-si (KR); Jungho LEE, Yongin-si (KR)

(21) Appl. No.: 17/375,365

(22) Filed: Jul. 14, 2021

(30) Foreign Application Priority Data
Jul. 15, 2020 (KR) 10-2020-0087609

(51) Int. Cl. H01M 4/36; H01M 4/485; H01M 4/38; H01M 10/0525; H01M 4/62

(52) U.S. Cl. CPC H01M 4/366; H01M 4/364; H01M 4/485; H01M 2004/027; H01M 10/0525; H01M 4/625; H01M 4/386

(57) ABSTRACT

A negative active material for a rechargeable lithium battery, a negative electrode, and a rechargeable lithium battery including the same, the negative active material including a core including silicon nanoparticles and a lithium titanium-based oxide; and an amorphous carbon layer on a surface of the core.

### CROSS-REFERENCE TO RELATED APPLICATION

This application claims priority to and the benefit of Korean Patent Application No. 10-2020-0087609 filed in the Korean Intellectual Property Office on Jul. 15, 2020, the entire contents of which are incorporated herein by reference.

### BACKGROUND

### 1. Field

Embodiments relate to a negative active material for a rechargeable lithium battery and a rechargeable lithium battery including the same.

### 2. Description of the Related Art

Rechargeable lithium batteries are attracting attention as power sources for various electronic devices because of high discharge voltage and high energy density.

As positive active materials of rechargeable lithium batteries, a lithium-transition metal oxide having a structure capable of intercalating lithium ions such as LiCoO₂, LiMn₂O₄, LiNi₁₋ₓCoₓO₂ (0<x<1), and the like has been considered.

As negative active materials of rechargeable lithium batteries, various carbon materials such as artificial graphite, natural graphite, and hard carbon capable of intercalating and deintercalating lithium ions, or silicon active materials have been used.

As electrolytes of rechargeable lithium batteries, an organic solvent in which a lithium salt is dissolved has been used.

### SUMMARY

The embodiments may be realized by providing a negative active material for a rechargeable lithium battery, the negative active material including a core including silicon nanoparticles and a lithium titanium-based oxide; and an amorphous carbon layer on a surface of the core.

The amorphous carbon layer may continuously surround the surface of the core.

The core may include the silicon nanoparticles and the lithium titanium-based oxide in the form of an aggregate assembly thereof.

The lithium titanium-based oxide may be represented by Chemical Formula 1:

Li₄₊ₓTi_{y}M_{z}Oₜ [Chemical Formula 1]

in Chemical Formula 1, 0≤x≤5, 1≤y≤5, 0≤z≤3, 3≤t≤12, and M may be Mg, La, Tb, Gd, Ce, Pr, Nd, Sm, Ba, Sr, Ca, or combination thereof.

The silicon nanoparticles and the lithium titanium-based oxide may be mixed in a weight ratio of about 95:5 to about 80:20.

A thickness of the amorphous carbon layer may be about 100 nm to about 2 μm.

The embodiments may be realized by providing a negative electrode for a rechargeable lithium battery, the negative electrode including a current collector; and a negative active material layer on the current collector, the negative active material layer including the negative active material according to an embodiment.

The negative active material layer may further include a crystalline carbon negative active material.

A total content of silicon nanoparticles and lithium titanium-based oxide in the negative active material layer may be greater than 0 wt % and less than or equal to about 9.5 wt %, based on 100 wt % of the negative active material layer.

A content of the silicon nanoparticles included in the negative active material layer may be about 2 times to about 10 times a content of the lithium titanium-based oxide in the negative active material layer.

The embodiments may be realized by providing a rechargeable lithium battery including the negative electrode according to an embodiment; a positive electrode including a positive active material; and a non-aqueous electrolyte.

### BRIEF DESCRIPTION OF THE DRAWINGS

Features will be apparent to those of skill in the art by describing in detail exemplary embodiments with reference to the attached drawings in which:

FIG. 1 is a view of a negative active material for a rechargeable lithium battery according to an embodiment.

FIG. 2 is a view of a rechargeable lithium battery according to another embodiment.

FIG. 3 is a graph showing high-rate cycle-life characteristics of the rechargeable lithium battery cells manufactured according to Example 1 and Comparative Examples 1 to 6.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

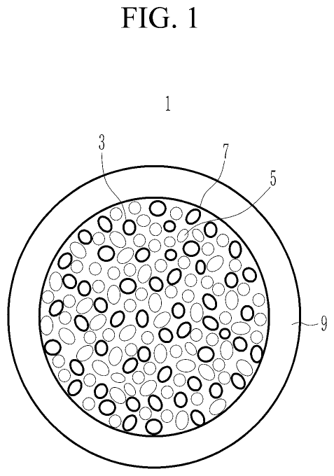

An embodiment may provide a negative active material for a rechargeable lithium battery including, e.g., a core including silicon nanoparticles and a lithium titanium-based oxide (e.g., a compound including lithium, titanium, and oxygen, and optionally including additional elements); and an amorphous carbon layer on the surface of the core. FIG. 1 shows a negative active material 1, in which the negative active material 1 may include a core 7 including silicon nanoparticles 3 and a lithium titanium-based oxide 5 and an amorphous carbon layer 9 on the surface of the core.

The amorphous carbon layer may be formed while continuously surrounding the surface of the core, e.g., may continuously surround or cover the surface of the core. In an implementation, the amorphous carbon layer may substantially or completely cover the surface of the core. In an implementation, the silicon nanoparticles and lithium titanium-based oxide included in the core may not be exposed to the outside. If the lithium titanium-based oxide were to be present on the surface of the active material and exposed to the outside, the specific surface area could increase, and irreversible by-products due to a reaction with the electrolyte could also increase, which could, e.g., decrease cycle-life. The active material according to an embodiment may be suitable because the lithium titanium-based oxide may be completely covered with the amorphous carbon layer, so that the issues related to exposure to the outside may not occur.

The amorphous carbon layer may have a thickness of, e.g., about 100 nm to about 2 μm. When the thickness of the amorphous carbon layer is included in the above range, the core surface may be completely covered without being exposed, and high capacity and high efficiency characteristics may be maintained, and cycle-life characteristics may also be improved. If the thickness of the amorphous carbon layer were to be thicker than the above range, capacity and efficiency may be lowered, which may not be appropriate or desirable.

In an implementation, the core may include the silicon nanoparticles and the lithium titanium-based oxide in the form of an aggregate assembly thereof, e.g., the silicon nanoparticles and the lithium titanium-based oxide may be aggregated and assembled to be included in the active material as an assembly. In an implementation, when the lithium titanium-based oxide is included in the core, the ion conductivity of lithium ions may be improved, thereby improving the intercalation and deintercalation of lithium ions to the inside of the silicon particles, thereby improving high power performance. In addition, this effect may be further maximized or enhanced when the lithium titanium-based oxide is aggregated with silicon nanoparticles having a higher resistance than graphite to form a core. If the lithium titanium-based oxide were to be on the surface of the active material, as mentioned above, the specific surface area of the active material could increase, which could cause deterioration of long cycle-life characteristics due to an increase in irreversible side products.

A mixing or weight ratio in which the silicon nanoparticles and the lithium titanium-based oxide may be mixed may be, e.g., about 95:5 to about 80:20. When the weight ratio of the silicon nanoparticles and the lithium titanium-based oxide is in the above range, high power characteristics may be improved without deterioration in capacity and efficiency. If the lithium titanium-based oxide were to be in excess of the above range, the capacity may be slightly lowered.

In the negative active material according to an embodiment, while maintaining the mixing ratio of the silicon nanoparticles and the lithium titanium-based oxide described above, the silicon nanoparticles may be included in an amount of about 45 wt % to about 70 wt %, based on a total weight (100 wt %) of the negative active material, and the lithium titanium-based oxide may be included in an amount of about 6 wt % to about 15 wt % based on 100 wt % of the negative active material. When the amounts of the silicon nanoparticles and lithium titanium-based oxide are included in the above range, excellent capacity and efficiency may be exhibited, and improved high power characteristics may be exhibited.

The particle diameter of the silicon nanoparticles may be, e.g., about 50 nm to about 200 nm. When the particle diameter of the silicon nanoparticles falls within the above range, there may be advantages of economical, easy handling, and small volume expansion during charging and discharging.

In the present specification, the particle diameter may be the average particle diameter of the particles. In this case, the average particle diameter may mean a particle diameter (D50) measured as a cumulative volume. Unless otherwise defined herein, the particle diameter (D50) means the average particle diameter (D50), which means the diameter of particles having a cumulative volume of 50 volume % in the particle size distribution.

The average particle size (D50) may be measured by a suitable method, e.g., by a particle size analyzer, by a transmission electron microscopic image, or a scanning electron microscopic image. In an implementation, a dynamic light-scattering measurement device may be used to perform a data analysis, and the number of particles is counted for each particle size range. From this, the average particle diameter (D50) value may be easily obtained through a calculation.

In an implementation, the lithium titanium-based oxide may be, e.g., represented by Chemical Formula 1.

Li₄₊ₓTi_{y}M_{z}Oₜ [Chemical Formula 1]

In Chemical Formula 1, 0≤x≤5, 1≤y≤5, 0≤z≤3, 3≤t≤12, and M may be, e.g., Mg, La, Tb, Gd, Ce, Pr, Nd, Sm, Ba, Sr, Ca, or a combination thereof. As used herein, the term “or” is not an exclusive term, e.g., “A or B” would include A, B, or A and B.

The lithium titanium-based oxide may have a particle diameter of, e.g., about 0.1 μm to about 6 If the particle size of the lithium titanium-based oxide is within the above range, there may be advantages electrochemically, and it may be uniformly dispersed with silicon without nozzle clogging or agglomeration in the active material preparation process, especially in the spray drying process.

The amorphous carbon may include, e.g., soft carbon, hard carbon, a mesophase pitch carbonized product, calcined coke, or a combination thereof.

In an implementation, a content or amount of the amorphous carbon may be, e.g., about 24 wt % to about 49 wt %, based on 100 wt % of the negative active material.

In the negative active material according to an embodiment, amorphous carbon may be present as a coating layer on the surface of the core. In an implementation, in the preparation process of the negative active material, amorphous carbon may naturally penetrate into some of the core and exist, but most of the amorphous carbon may be present as a coating layer on the surface of the core.

If the amorphous carbon were to be mostly present inside the core, e.g., if the active material were to be prepared by mixing silicon nanoparticles, lithium titanium-based oxide, and an amorphous carbon precursor together, pores could be generated in the heat treatment process and the inside thereof may not be dense, and cycle-life characteristics could be deteriorated.

In addition, the negative active material according to the embodiment may not include crystalline carbon, may have higher capacity and efficiency, and may exhibit excellent cycle-life characteristics, compared to the negative active material including crystalline carbon.

The negative active material according to an embodiment may be prepared by the following process.

First, the silicon nanoparticles and the lithium titanium-based oxide may be mixed in a solvent. In an implementation, the silicon nanoparticles and the lithium titanium-based oxide may be mixed in a weight ratio of about 95:5 to about 80:20. When the silicon nanoparticles and the lithium titanium-based oxide are mixed within the range, high power characteristics may be improved without deteriorating capacity and efficiency. The solvent may include, e.g., ethanol, isopropyl alcohol, deionized water, or a combination thereof.

The silicon nanoparticles may be obtained by pulverizing silicon particles, and this pulverization process may include ball milling and the like. In this pulverization process, a dispersing agent may be further included, e.g., stearic acid, boron nitride (BN), MgS, polyvinyl pyrrolidone (PVP), or a combination thereof.

The obtained mixture may be dried. This drying process may be performed through a spray drying process. As the drying process is performed using the spray drying process, a dried product having particles with a uniform particle diameter and a spherical shape may be formed. When this dried product is the particles with a uniform particle diameter and a spherical shape, an amorphous carbon layer formed thereafter may be more uniformly formed on the entire surfaces thereof.

On the dried product, the amorphous carbon layer may be formed. The amorphous carbon layer-forming process may be performed by vapor-coating amorphous carbon precursor gas or mixing and carbonizing the dried product and an amorphous carbon precursor.

The amorphous carbon precursor gas may include, e.g., methane (CH₄) gas, ethylene (C₂H₄) gas, acetylene (C₂H₂) gas, propane (C₃H₈) gas, propylene (C₃H₆) gas, or a combination thereof, and the amorphous carbon precursor may include, e.g., a petroleum-based coke, a coal-based coke, a petroleum pitch, a coal pitch, a green coke, or a combination thereof.

When the amorphous carbon layer is formed by mixing and carbonizing the dried product and the amorphous carbon precursor, a mixing ratio of the dried product and the amorphous carbon precursor may be adjusted, so that the silicon nanoparticles, the lithium titanium-based oxide, and the amorphous carbon may be respectively in a range of about 45 wt % to about 70 wt %, about 6 wt % to about 15 wt %, and about 24 wt % to about 49 wt % in a final product. In an implementation, the carbonization process may be performed at, e.g., about 600° C. to about 1,000° C.

Another embodiment provides a negative electrode for a rechargeable lithium battery including a current collector and a negative active material layer on the current collector and including the negative active material.

The negative active material may include the negative active material according to an embodiment as a first negative active material and crystalline carbon as a second negative active material. The crystalline carbon negative active material may be graphite, for example artificial graphite, natural graphite, a combination thereof. When the crystalline carbon is included as a second negative active material, the first negative active material and the second negative active material may be mixed in a weight ratio of, e.g., about 1:30 to about 1:4. When the first negative active material and the second negative active material are used in the aforementioned mixing ratio, higher specific capacity is obtained, and thus more excellent energy density may be obtained.

When the negative active material includes the negative active material according to an embodiment as a first negative active material and crystalline carbon as a second negative active material, a sum of amounts of the silicon nanoparticles and the lithium titanium-based oxide included in the negative active material layer may be less than or equal to about 9.5 wt %, e.g., about 4.75 wt % to about 9.5 wt %, based on 100 wt % of the negative active material layer. In an implementation, an amount of the silicon nanoparticles may be about 2 to about 10 times larger than that of the lithium titanium-based oxide included in the negative active material layer.

When the negative active material includes the first negative active material and the second negative active material, a sum of amounts of the silicon nanoparticles and the lithium titanium-based oxide may be less than or equal to about 10 wt %, e.g., about 5 wt % to about 10 wt %, based on 100 wt % of the negative active material. In an implementation, the amount of the silicon nanoparticles may be about 3 wt % to about 9 wt %, based on 100 wt % of the negative active material, and the amount of the lithium titanium-based oxide may be about 0.5 wt % to about 1.5 wt %, based on 100 wt % of the negative active material.

When the total or sum amounts of the silicon nanoparticles and the lithium titanium-based oxide are within the ranges, long cycle-life characteristics as well as high energy density, e.g., energy density of about 700 wh/l to about 900 wh/l may be achieved. In an implementation, when the silicon nanoparticles are present in an amount of, e.g., about 2 to about 10 times that of the lithium titanium-based oxide, high capacity, high power, and long cycle-life characteristics may be obtained.

The negative active material layer may include a negative active material and a binder, and may optionally further include a conductive material.

In the negative active material layer, the negative active material may be included in an amount of, e.g., about 95 wt % to about 99 wt %, based on the total weight of the negative active material layer. In the negative active material layer, an amount of the binder may be, e.g., about 1 wt % to about 5 wt %, based on the total weight of the negative active material layer. When the negative active material layer includes a conductive material, the negative active material layer may include, e.g., about 90 wt % to about 98 wt % of the negative active material, about 1 wt % to about 5 wt % of the binder, and about 1 wt % to about 5 wt % of the conductive material.

The binder may help improve binding properties of negative active material particles with one another and with a current collector. The binder ma include, e.g., a non-aqueous binder, an aqueous binder, or a combination thereof.

The non-aqueous binder may include, e.g., an ethylenepropylene copolymer, polyacrylonitrile, polystyrene, polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The aqueous binder may include, e.g., a styrene-butadiene rubber, an acrylated styrene-butadiene rubber, an acrylonitrile-butadiene rubber, an acrylic rubber, a butyl rubber, a fluorine rubber, an ethylene oxide-containing polymer, polyvinylpyrrolidone, polyepichlorohydrine, polyphosphazene, an ethylenepropylenediene copolymer, polyvinylpyridine, chlorosulfonatedpolyethylene, latex, a polyester resin, an acrylic resin, a phenolic resin, an epoxy resin, polyvinyl alcohol, or a combination thereof.

When the aqueous binder is used as a negative electrode binder, a cellulose-based compound may be further included to provide viscosity as a thickener. The cellulose-based compound may include, e.g., carboxymethyl cellulose, hydroxypropylmethyl cellulose, methyl cellulose, or alkali metal salts thereof. The alkali metal may be, e.g., Na, K, or Li. The thickener may be included in an amount of about 0.1 parts by weight to about 3 parts by weight, based on 100 parts by weight of the negative active material.

The conductive material may be included to provide electrode conductivity. A suitable electrically conductive material that does not cause a chemical change may be used as the conductive material. Examples of the conductive material may include a carbon-based material such as natural graphite, artificial graphite, carbon black, acetylene black, Ketjen black, Denka black, carbon fiber, or the like; a metal-based material of a metal powder or a metal fiber including copper, nickel, aluminum silver, or the like; a conductive polymer such as a polyphenylene derivative; or a mixture thereof.

The current collector may include, e.g., a copper foil, a nickel foil, a stainless steel foil, a titanium foil, a nickel foam, a copper foam, a polymer substrate coated with a conductive metal, or a combination thereof.

Another embodiment provides a rechargeable lithium battery including the negative electrode, the positive electrode, and a non-aqueous electrolyte.

The positive electrode may include a current collector and a positive active material layer on the current collector and including a positive active material.

A compound capable of intercalating and deintercallating lithium (lithiated intercalation compound) may be used as the positive active material. In an implementation, one or more composite oxides of a metal selected from cobalt, manganese, nickel, and a combination thereof, and lithium may be used. In an implementation, a compound represented by any one of the following chemical formulas may be used. LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}D_{α} (0.90<α≤1.8, 0≤b≤0.5, 0≤c≤0.5, 0≤α≤2); LiₐNi_{1-b-c}Co_{b}X_{c}O_{2-α}T_{α} (0.90≤a≤1.8, 0≤b≤0.5, 0≤c≤0.05, 0<α<2); LiₐNi_{1-b-c}Co_{b}X_{c}O_{2-α}T₂ (0.90≤a≤1.8, 0≤b≤0.5, 0≤c≤0.5, 0<α<2); LiₐNi_{1-b-c}Mn_{b}X_{c}D_{α} (0.90≤a≤1.8, 0≤b≤0.5, 0≤c≤0.5, 0<α≤2); LiₐNi_{1-b-c}Mn_{b}X_{c}O_{2-α}T_{α} (0.90≤a≤1.8, 0≤b≤0.5, 0≤c≤0.5, 0<α<2); LiₐNi_{1-b-c}Mn_{b}X_{c}O_{2-α}T₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiₐFePO₄ (0.90≤a≤1.8).

In the chemical formulas, A may be selected from Ni, Co, Mn, and a combination thereof; X may be selected from Al, Ni, Co, Mn, Cr, Fe, Mg, Sr, V, a rare earth element, and a combination thereof; D may be selected from O, F, S, P, and a combination thereof; E may be selected from Co, Mn, and a combination thereof; T may be selected from F, S, P, and a combination thereof; G may be selected from Al, Cr, Mn, Fe, Mg, La, Ce, Sr, V, and a combination thereof; Q may be selected from Ti, Mo, Mn, and a combination thereof; Z may be selected from Cr, V, Fe, Sc, Y, and a combination thereof; and J may be selected from V, Cr, Mn, Co, Ni, Cu, and a combination thereof.

The compounds may have a coating layer on the surface, or may be mixed with another compound having a coating layer. The coating layer may include a coating element compound, e.g., an oxide of a coating element, a hydroxide of a coating element, an oxyhydroxide of a coating element, an oxycarbonate of a coating element, or a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive active material by using these elements in the compound. In an implementation, the method may include a suitable coating method (e.g., spray coating, dipping, or the like).

In the positive electrode, the amount of the positive active material may be about 90 wt % to about 98 wt %, based on the total weight of the positive active material layer.

In an implementation, the positive active material layer may further include a binder and a conductive material. In an implementation, the amount of the binder and the conductive material may be, e.g., about 1 wt % to about 5 wt %, respectively, based on the total weight of the positive active material layer.

The binder may help improve binding properties of positive active material particles with one another and with a current collector. Examples thereof may include polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like.

The conductive material may impart conductivity to the electrode, and a suitable material that does not cause a chemical change in the battery may be used and that is an electron conductive material. Examples of the conductive material may include a carbon-based material such as natural graphite, artificial graphite, carbon black, acetylene black, Ketjen black, a carbon fiber, and the like; a metal-based material of a metal powder or a metal fiber including copper, nickel, aluminum, silver, and the like; a conductive polymer such as a polyphenylene derivative; or a mixture thereof.

The current collector may include, e.g., an aluminum foil, a nickel foil, or a combination thereof.

The positive active material layer and the negative active material layer may be formed by mixing an active material, a binder, and optionally a conductive material in a solvent to prepare an active material composition, and applying the active material composition to a current collector. The solvent may include, e.g., N-methylpyrrolidone or the like. In an implementation, when an aqueous binder is used for the negative active material layer, water may be used as a solvent used in preparing the negative active material composition.

The electrolyte may include, e.g., a non-aqueous organic solvent and a lithium salt.

The non-aqueous organic solvent may serve as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include, e.g., dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester-based solvent may include, e.g., methyl acetate, ethyl acetate, n-propyl acetate, dimethylacetate, methylpropionate, ethylpropionate, propyl propionate, decanolide, mevalonolactone, caprolactone, or the like. The ether-based solvent may include, e.g., dibutyl ether, tetraglyme, diglyme, dimethoxyethane, 2-methyltetrahydrofuran, tetrahydrofuran, or the like. The ketone-based solvent may include, e.g., cyclohexanone or the like. The alcohol-based solvent may include, e.g., ethyl alcohol, isopropyl alcohol, or the like. The aprotic solvent may include, e.g., nitriles such as R—CN (where R is a C2 to C20 linear, branched, or cyclic hydrocarbon, or may include a double bond, an aromatic ring, or an ether bond), amides such as dimethylformamide, dioxolanes such as 1,3-dioxolane, sulfolanes, and the like.

The non-aqueous organic solvent may be used alone or in a mixture of one or more. When the organic solvent is used in a mixture, a mixture ratio may be controlled in accordance with a desirable battery performance.

The carbonate-based solvent is prepared by mixing a cyclic carbonate and a linear carbonate. The cyclic carbonate and linear carbonate are mixed together in a volume ratio of about 1:1 to about 1:9. When the mixture is used as an electrolyte, it may have enhanced performance.

When the non-aqueous organic solvent is mixed and used, a mixed solvent of a cyclic carbonate and a chain carbonate, a mixed solvent of a cyclic carbonate and a propionate-based solvent, or a mixed solvent of a cyclic carbonate, a chain carbonate, and a propionate-based solvent may be used. The propionate-based solvent may include, e.g., methyl propionate, ethyl propionate, propyl propionate, or a combination thereof.

In an implementation, when the cyclic carbonate and the chain carbonate or the cyclic carbonate and the propionate-based solvent are mixed, they may be mixed in a volume ratio of about 1:1 to about 1:9, and performance of an electrolyte solution may be improved. In an implementation, when the cyclic carbonate, the chain carbonate, and the propionate-based solvent are mixed, they may be mixed in a volume ratio of about 1:1:1 to about 3:3:4. The mixing ratios of the solvents may be appropriately adjusted according to desirable properties.

The non-aqueous organic solvent may further include an aromatic hydrocarbon-based organic solvent in addition to the carbonate-based solvent. In an implementation, the carbonate-based solvent and the aromatic hydrocarbon-based organic solvent may be mixed in a volume ratio of about 1:1 to about 30:1.

In an implementation, the aromatic hydrocarbon-based organic solvent may be an aromatic hydrocarbon-based compound of Chemical Formula 2.

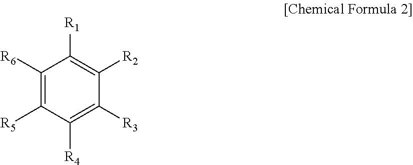

In Chemical Formula 2, R₁ to R₆ may each independently be, e.g., hydrogen, a halogen, a C1 to C10 alkyl group, a haloalkyl group, or a combination thereof.

Examples of the aromatic hydrocarbon-based organic solvent may include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include an additive of vinylene carbonate or an ethylene carbonate-based compound of Chemical Formula 3, e.g., in order to improve a cycle-life of a battery, as an additive for increasing the cycle-life.

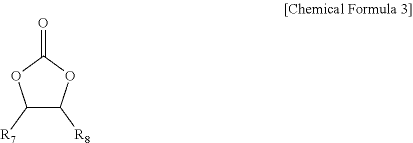

In Chemical Formula 3, R₇ and R₈ may each independently be, e.g., hydrogen, a halogen, a cyano group (CN), a nitro group (NO₂), or a fluorinated C1 to C5 alkyl group. In an implementation, at least one of R₇ and R₈ may be, e.g., a halogen, a cyano group (CN), a nitro group (NO₂), or a fluorinated C1 to C5 alkyl group, and R₇ and R₈ may not both be hydrogen.

Examples of the ethylene carbonate-based compound may include difluoro ethylenecarbonate, chloroethylene carbonate, dichloroethylene carbonate, bromoethylene carbonate, dibromoethylene carbonate, nitroethylene carbonate, cyanoethylene carbonate, and fluoroethylene carbonate. The amount of the additive for improving a cycle-life may be used within an appropriate range.

In an implementation, the electrolyte may further include vinylethylene carbonate, propane sultone, succinonitrile, or a combination thereof, and the amount used may be appropriately adjusted.

The lithium salt dissolved in an organic solvent may supply a battery with lithium ions, basically operates the rechargeable lithium battery, and improves transportation of the lithium ions between positive and negative electrodes. Examples of the lithium salt may include LiPF₆, LiBF₄, LiSbF₆, LiAsF₆, LiN(SO₂C₂F₅)₂, Li(CF₃SO₂)₂N, LiN (SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂), wherein, x and y are natural numbers, for example an integer ranging from 1 to 20, LiCl, LiI, and LiB(C₂O₄)₂ (lithium bis(oxalato) borate:LiBOB). A concentration of the lithium salt may range from about 0.1 M to about 2.0 M. When the lithium salt is included at the above concentration range, an electrolyte may have excellent performance and lithium ion mobility due to optimal electrolyte conductivity and viscosity.

The rechargeable lithium battery may further include a separator between the negative electrode and the positive electrode, depending on a kind of the battery. Examples of a suitable separator material may include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

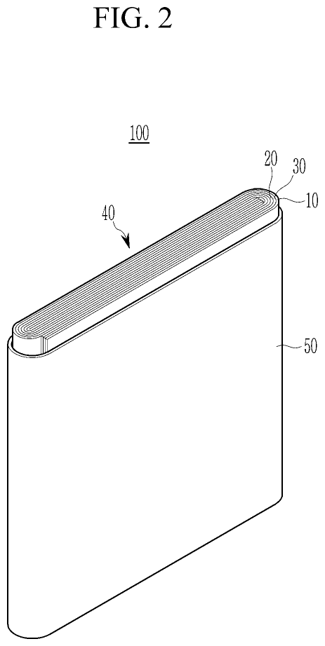

FIG. 2 is an exploded perspective view of a rechargeable lithium battery according to one embodiment. As illustrated in the drawings, the rechargeable lithium battery may be a prismatic battery, or may include variously-shaped batteries such as a cylindrical battery, a pouch battery, or the like.

Referring to FIG. 2, a rechargeable lithium battery 100 according to an embodiment may include an electrode assembly 40 manufactured by winding a separator 30 between a positive electrode 10 and a negative electrode 20, and a case 50 housing the electrode assembly 40. An electrolyte may be impregnated in the positive electrode 10, the negative electrode 20, and the separator 30.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

Silicon and a stearic acid dispersing agent were mixed and then, ball-milled, preparing silicon nanoparticles having an average particle diameter (D50) of 100 nm.

The silicon nanoparticles and Li₄Ti₅O₁₂ (LTO, theoretical density: 3.40 g/cm³, an average particle diameter (D50): 1.2 μm) were mixed in a weight ratio of 88:12 (in a volume ratio of 91.5:8.5) in isopropyl alcohol, obtaining a mixture.

The mixture was spray-dried, and this dried product was mixed with a petroleum pitch amorphous carbon precursor in order to have a weight ratio of Si:amorphous carbon:LTO=60:32:8 in a final product and then, carbonized at 950° C., preparing a first negative active material. According to the carbonization process, the amorphous carbon precursor was converted into amorphous carbon, the first negative active material included a core including the silicon nanoparticles and Li₄Ti₅O₁₂ and an amorphous carbon layer thereon. The amorphous carbon layer had a thickness of 500 nm.

97.8 wt % of a mixed negative active material of the first negative active material and artificial graphite (12.0 wt %:88.0 wt %), 1.2 wt % of a styrene-butadiene rubber binder, and 1.0 wt % of carboxymethyl cellulose were mixed in water, preparing negative active material slurry.

The negative active material slurry was coated on a copper foil and then, dried and compressed, manufacturing a negative electrode including a negative active material layer formed on the copper foil current collector.

In the negative active material layer, the amounts of the silicon nanoparticles and LTO were 8.16 wt % based on 100 wt % of the total negative active material, wherein an amount of the silicon nanoparticles was 7.2 wt % based on 100 wt % of the total negative active material, while an amount of LTO was 0.96 wt %, and accordingly, the amount of the silicon nanoparticles was 7.5 times larger than that of LTO. In addition, the amounts of the silicon nanoparticles and LTO based on 100 wt % of the total negative active material layer were 7.75 wt %, wherein the amount of the silicon nanoparticles was 6.84 wt % based on 100 wt % of the total negative active material layer, while the amount of LTO was 0.91 wt %, and accordingly, the amount of the silicon nanoparticles was 7.5 times larger than that of LTO.

96 wt % of a LiNi_{0.88}Co_{0.1}Al_{0.02}O₂ positive active material, 2 wt % of a ketjen black conductive material, and 2 wt % of polyvinylidene fluoride were mixed in N-methylpyrrolidone, preparing positive active material slurry. The positive active material slurry was coated on an aluminum foil and then, dried and compressed, manufacturing a positive electrode.

The negative electrode, the positive electrode, and an electrolyte solution were used, manufacturing a 4.2 V-level cylindrical rechargeable lithium battery cell. The electrolyte solution was prepared by dissolving LiPF₆ to form a 1.0 M solution in a mixed solvent of ethylene carbonate, diethyl carbonate, and dimethyl carbonate (in a volume ratio of 3/5/2).

### Example 2

Silicon and a stearic acid dispersing agent were mixed and then, ball-milled, preparing silicon nanoparticles having an average particle diameter (D50) of 100 nm.

The silicon nanoparticles and Li₄Ti₅O₁₂ (LTO, theoretical density: 3.40 g/cm³, an average particle diameter (D50): 1.2 μm) in a weight ratio of 88:12 (in a volume ratio of 91.5:8.5) were mixed in isopropyl alcohol, preparing a mixture.

The mixture was spray-dried, and a petroleum pitch amorphous carbon precursor was mixed with this dried product in order to have a weight ratio of Si:amorphous carbon:LTO=52.8:40:7.2 in a final product and then, carbonized at 950° C., preparing a first negative active material. According to the carbonization process, the amorphous carbon precursor was converted into amorphous carbon, the first negative active material included a core including the silicon nanoparticles and Li₄Ti₅O₁₂ and an amorphous carbon layer thereon. The amorphous carbon layer had a thickness of 1 μm.

97.8 wt % of a mixed negative active material of the first negative active material and artificial graphite (14.3 wt %:85.7 wt %), 1.2 wt % of a styrene-butadiene rubber binder, and 1.0 wt % of carboxymethyl cellulose were mixed in water, preparing negative active material slurry.

The negative active material slurry was coated on a copper foil and then, dried and compressed, manufacturing a negative electrode including a negative active material layer formed on the copper foil current collector.

In the negative active material layer, amounts of the silicon nanoparticles and LTO were 8.58 wt % based on 100 wt % of the total negative active material, wherein an amount of the silicon nanoparticles was 7.55 wt % based on 100 wt % of the total negative active material, and an amount of LTO was 1.03 wt % based on 100 wt % of the total negative active material, and accordingly, the amount of the silicon nanoparticles was 7.3 times larger than that of LTO. In addition, the amounts of the silicon nanoparticles and LTO were 8.15 wt % based on 100 wt % of the total negative active material layer, wherein the amount of the silicon nanoparticles was 7.17 wt % based on 100 wt % of the total negative active material layer, and an amount of LTO was 0.98 wt % based on 100 wt % of the total negative active material layer, and accordingly, the amount of the silicon nanoparticles was 7.3 times larger than that of LTO.

A rechargeable lithium battery cell was manufactured in the same manner as in Example 1 except that the negative electrode described above was used.

### Comparative Example 1

A first negative active material was prepared according to the same method as Example 1 except that the silicon nanoparticles and the petroleum pitch amorphous carbon precursor were mixed in order to have a weight ratio of Si:C=60:40 in a final product and then, carbonized at 950° C.

96.8 wt % of a mixed active material of the first negative active material and an artificial graphite second negative active material (12 wt %:88 wt %), 1 wt % of Li₄Ti₅O₁₂, 1.2 wt % of a styrene-butadiene rubber binder, and 1 wt % of carboxymethyl cellulose were mixed in water, preparing negative active material slurry.

The negative active material slurry was coated on a copper foil and then, dried and compressed, manufacturing a negative electrode including a negative active material layer formed on a foil current collector.

A rechargeable lithium battery cell was manufactured in the same manner as in Example 1 except that the negative electrode described above was used.

### Comparative Example 2

97.8 wt % of a mixed active material of the first negative active material according to Comparative Example 1 and an artificial graphite second negative active material (12 wt %:88 wt %), 1.2 wt % of a styrene-butadiene rubber binder, and 1 wt % of carboxymethyl cellulose were mixed in a water solvent, preparing negative active material slurry.

The negative active material slurry was coated on a copper foil and then, dried and compressed, manufacturing a negative electrode including a negative active material layer formed on the copper foil current collector.

A rechargeable lithium battery cell was manufactured in the same manner as in Example 1 except that the negative electrode described above was used.

### Comparative Example 3

97.8 wt % of a mixed negative active material of artificial graphite and Si-carbon composite mixed in a weight ratio of 82:18, 1.2 wt % of a styrene-butadiene rubber binder, and 1 wt % of carboxymethyl cellulose were mixed in water, preparing negative active material slurry.

The negative active material slurry was coated on a copper foil and then, dried and compressed, manufacturing a negative electrode. Herein, the Si-carbon composite had a core including natural graphite and silicon particles and soft carbon coated on the surface of the core, wherein an amount of the natural graphite was 40 wt %, based on 100 wt % of the Si-carbon composite, an amount of the silicon particles was 40 wt %, and an amount of the amorphous carbon was 20 wt %. The soft carbon coating layer had a thickness of 20 nm, and the silicon particles had an average particle diameter (D50) of 100 nm.

A rechargeable lithium battery cell was manufactured in the same manner as in Example 1 except that the negative electrode described above was used.

### Comparative Example 4

96.8 wt % of a mixed negative active material of artificial graphite and Si-carbon composite in a weight ratio of 82:18, 1 wt % of Li₄Ti₅O₁₂, 1.2 wt % of a styrene-butadiene rubber binder, and 1 wt % of carboxymethyl cellulose were mixed in water, preparing negative active material slurry.

The negative active material slurry was coated on a copper foil and then, dried and compressed, manufacturing a negative electrode. Herein, the Si-carbon composite had a core including natural graphite and silicon particles and soft carbon coated on the surface of the core, an amount of the natural graphite was 40 wt %, based on 100 wt % of the Si-carbon composite, an amount of the silicon particles was 40 wt %, and an amount of the amorphous carbon was 20 wt %. The soft carbon coating layer had a thickness of 20 nm, and the silicon particles had an average particle diameter (D50) of 100 nm.

A rechargeable lithium battery cell was manufactured in the same manner as in Example 1 except that the negative electrode described above was used.

### Comparative Example 5

The silicon nanoparticles according to Example 1, Li₄Ti₅O₁₂, and natural graphite were mixed in a weight ratio of 50:8:42 in isopropyl alcohol, preparing a mixture.

The mixture was spray-dried, and a petroleum pitch amorphous carbon precursor was added to the spray-dried product in order to have a weight ratio of Si:natural graphite:amorphouscarbon:LTO=40:33.6:20:6.4 in a final product and carbonized at 950° C., preparing a first negative active material.

97.8 wt % of a mixed negative active material of the first negative active material and artificial graphite (18 wt %:82 wt %), 1.2 wt % of a styrene-butadiene rubber binder, and 1 wt % of carboxymethyl cellulose were mixed in water, preparing negative active material slurry.

The negative active material slurry was coated on a copper foil and then, dried and compressed, manufacturing a negative electrode including a negative active material layer formed on the copper foil current collector.

A rechargeable lithium battery cell was manufactured in the same manner as in Example 1 except that the negative electrode described above was used.

### Comparative Example 6

The silicon nanoparticles according to Example 1, Li₄Ti₅O₁₂, and soft carbon were mixed in a weight ratio of 60:10:30, preparing a first negative active material.

97.8 wt % of a mixed active material of the first negative active material and an artificial graphite second negative active material (12 wt %:88 wt %), and 1.2 wt % of a styrene-butadiene rubber binder, and 1 wt % of carboxymethyl cellulose were mixed in water, preparing negative active material slurry.

The negative active material slurry was coated on a copper foil and then, dried and compressed, manufacturing a negative electrode including a negative active material layer formed on the copper foil current collector.

A rechargeable lithium battery cell was manufactured in the same manner as in Example 1 except that the negative electrode described above was used.

### Experimental Example 1: Evaluation of High-Rate Cycle-Life Characteristics

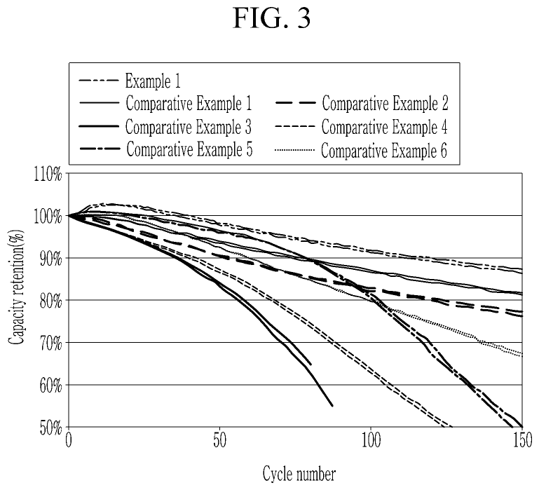

The lithium battery cells according to Example 1 and Comparative Examples 1 to 6 were manufactured by two each and then, charged at 1.0 C under a cut-off condition of 4.0 V and 0.05 C and discharged at 1.0 C under a cut-off condition of 2.5 V, and this charge and discharge was repeated 150 times to measure capacity retention relative to 1^{st} capacity, and the results are shown in FIG. 3. As shown in FIG. 3, even though a rechargeable lithium battery cell using the negative active material having a core including silicon nanoparticles and lithium titanium oxide according to Example 1 was charged and discharged 150 times at a high rate of 1.0 C, high capacity retention of about 88% was obtained. On the contrary, Comparative Example 1, in which Si—C composite and lithium titanium oxide were physically mixed, e.g., the Si—C composite was present on the surface of the lithium titanium oxide, exhibited deteriorated capacity retention of about 80%, and Comparative Example 2 in which only Si—C composite is mixed without lithium titanium oxide exhibited more deteriorated capacity retention. Comparative Examples 3 and 4 including no lithium titanium oxide exhibited sharply deteriorated capacity retention.

Even through the lithium titanium oxide was included in the core, Comparative Example 5 (further using natural graphite in the core) exhibited significantly deteriorated capacity retention when charged and discharged about 80 times.

Comparative Example 6, in which silicon nanoparticles, lithium titanium oxide, and soft carbon were mixed, also exhibited significantly deteriorated capacity retention.

By way of summation and review, for the manufacture of high-capacity batteries, silicon active materials have been considered.

One or more embodiments may provide a negative active material for a rechargeable lithium battery exhibiting excellent high rate capability, cycle-life characteristics, and reduced ionic resistance.

The negative active material for a rechargeable lithium battery according to an embodiment may have excellent high rate characteristics and cycle-life characteristics, and may exhibit reduced ionic resistance.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative active material for a rechargeable lithium battery, the negative active material comprising:
a core including silicon nanoparticles and a lithium titanium-based oxide; and
an amorphous carbon layer on a surface of the core.

2. The negative active material as claimed in claim 1, wherein the amorphous carbon layer continuously surrounds the surface of the core.

3. The negative active material as claimed in claim 1, wherein the core includes the silicon nanoparticles and the lithium titanium-based oxide in the form of an aggregate assembly thereof.

4. The negative active material as claimed in claim 1, wherein:
the lithium titanium-based oxide is represented by Chemical Formula 1:
Li₄₊ₓTi_{y}M_{z}Oₜ [Chemical Formula 1]
in Chemical Formula 1, 0≤x≤5, 1≤y≤5, 0≤z≤3, 3≤t≤12, and M is Mg, La, Tb, Gd, Ce, Pr, Nd, Sm, Ba, Sr, Ca, or combination thereof.

5. The negative active material as claimed in claim 1, wherein the silicon nanoparticles and the lithium titanium-based oxide are mixed in a weight ratio of about 95:5 to about 80:20.

6. The negative active material as claimed in claim 1, wherein a thickness of the amorphous carbon coating layer is about 100 nm to about 2 μm.

7. A negative electrode for a rechargeable lithium battery, the negative electrode comprising:
a current collector; and
a negative active material layer on the current collector, the negative active material layer including the negative active material as claimed in claim 1.

8. The negative electrode as claimed in claim 7, wherein the negative active material layer further includes a crystalline carbon negative active material.

9. The negative electrode as claimed in claim 8, wherein a total content of silicon nanoparticles and lithium titanium-based oxide in the negative active material layer is greater than 0 wt % and less than or equal to about 9.5 wt %, based on 100 wt % of the negative active material layer.

10. The negative electrode as claimed in claim 7, wherein a content of the silicon nanoparticles included in the negative active material layer is about 2 times to about 10 times a content of the lithium titanium-based oxide in the negative active material layer.

11. A rechargeable lithium battery, comprising:
the negative electrode as claimed in claim 7;
a positive electrode including a positive active material; and
a non-aqueous electrolyte.
